(19) United States
(12) Patent Application Publication
(10) Pub. No.: US 2014/0057075 A1
(43) Pub. Date: Feb. 27, 2014

(54) HIGH-PRESSURE FIRE-RETARDANT MATERIAL WITH METAL LAYER AND METHOD FOR MAKING THE SAME

(71) Applicant: Chao-Lang WANG, New Taipei City (TW)

(72) Inventor: Chao-Lang WANG, New Taipei City (TW)

(21) Appl. No.: 13/655,745

(22) Filed: Oct. 19, 2012

(30) Foreign Application Priority Data
Aug. 23, 2012 (TW) 101130622

(51) Int. Cl. B32B 3/24; B32B 37/12

(52) U.S. Cl. 428/138; 156/242

(57) ABSTRACT

The present invention is to provide a high-pressure fire-retardant material, which includes at least one metal layer each being a plate made of a metal material, having a thickness less than 2 mm, and evenly formed with a plurality of mesh holes by stamping; at least one fiber layer each being a board composed of a fibrous material and having a thickness less than 2 mm; and at least one bonding layer each located between one metal layer and one fiber layer. The bonding layer is formed by curing a composite material made of an even mixture of an adhesive and a fire-resistant material, wherein the fire-resistant material is in a form of powder or particles and makes up 45% to 65% by weight of the composite material. Once cured, the composite material forms the bonding layer and is embedded in the mesh holes and pores of the fiber layer.

### FIELD OF THE INVENTION

The present invention relates to a fire-retardant material, more particularly to a high-pressure fire-retardant material having at least one metal layer and at least one fiber layer, wherein the metal layer and fiber layer are attached to each other through an adhesive composite material, that is made of an even mixture of an adhesive and a fire-resistant material, under a high pressure. Once the composite material is cured, the composite material forms a bonding layer between the metal layer and fiber layer and, at the meanwhile, is embedded in mesh holes on the metal layer and pores of the fiber layer, so as to provide a fire-retardant, lightweight, tough, and easily processable material.

### BACKGROUND OF THE INVENTION

Traditionally, indoor/outdoor decorative wall panels, flooring, door panels, and outdoor furniture are mainly made of wood, stone, and tiles, among others. When stone or tiles are used as the major building materials, their resistance to fire is often eclipsed by difficulties in material processing, which result in high construction costs. The weight and poor attachment of these two materials also increase transportation and construction costs and may raise safety issues should they come off the surface to which they are attached. Moreover, the high material costs of stone and tiles add significantly to the users' expenses.

As to the various kinds of woods, their slow growth rates and material properties disadvantageously lead to high prices, a lack of fire resistance, the tendency of warping due to dampness, insect damages, and the fading of surface colors. Generally speaking, wood as a building material can take many forms, including blockboard, plywood, medium-density fiberboard (MDF), and particle board, for example. Lighter than stone and tiles, blockboard is less susceptible to deformation and is capable of bearing a greater weight than the other types of wood building materials. However, blockboard is still heavier than many other building materials and therefore inconvenient to use. Plywood, MDF, and particle board are relatively lightweight and relatively easy to process, thanks to their wood chip composition, but are disadvantaged by low toughness. Besides, neither plywood nor MDF nor particle board can apply a strong holding force to a screw driven therein. If the screw is subjected to a great external force (e.g., the weight of a heavy object hung thereon) for a long time, it is very likely that the screw will get loose or even come out of the screw hole. Hence, plywood, MDF, and particle board are generally regarded as less durable. In addition to the respective drawbacks cited above, a lack of fire resistance is a fatal disadvantage shared by all wood materials.

In a modern society which places great importance on the safety of buildings, it is common practice to make indoor/outdoor decorative wall panels, flooring, door panels, outdoor furniture, etc. out of fire-retardant building materials, for which strict testing standards have been established worldwide. It is also stipulated by law in many countries that partition boards or decorative panels for use in public places should be made of fire-retardant building materials to ensure the personal and property safety of those who access such places. In view of the aforementioned drawbacks of the conventional building materials, a variety of fire-retardant materials have been developed and brought to the market, and more and more places are using fire-retardant materials instead as major building materials. Nowadays, fire-retardant materials are typically made of concrete, gypsum, and so forth, which ingredients, however, still result in a considerable weight. To solve this problem, lightweight thermal insulation materials such as vermiculite, resin, and chemical adhesives are added into the conventional fire-retardant materials to make lightweight fire-retardant boards, but these boards are brittle and therefore highly vulnerable to damage during handling; as a result, transportation and construction costs stay high.

It can be known from the above that neither the traditional building materials (e.g., wood, stone, and tiles) nor the existing fire-retardant materials are fire-retardant, lightweight, tough, and easily processable at the same time and can be used without incurring high transportation and construction costs. Some of the materials are even lacking in utility or durability (e.g., not suitable for use with screws for hanging heavy objects). Moreover, now that stone and tiles are difficult to process, and wood and the existing fire-retardant materials are generally manufactured in the form of planar plates or boards, all these materials are severely limited in design and hence in application.

The issue to be addressed by the present invention is to develop a novel fire-retardant material which not only is fire-retardant, lightweight, tough, and readily processable, but also can take various forms as needed, so as to have wider applicability than the prior art and solve the aforementioned problems of the traditional building materials and the existing fire-retardant materials.

### BRIEF SUMMARY OF THE INVENTION

In light of the various drawbacks of the traditional building materials such as wood, stone, and tiles and of the existing fire-retardant materials, the inventor of the present invention studied related literature, conducted extensive experiment, and after repeated adjustments and improvements, finally succeeded in developing a high-pressure fire-retardant material having a metal layer and a method for making the same. It is hoped that the present invention can overcome the various drawbacks of the conventional materials and provide a high-pressure fire-retardant material which is fire-retardant, lightweight, tough, and easily processable.

It is an object of the present invention to provide a high-pressure fire-retardant material having a metal layer. The high-pressure fire-retardant material includes at least one metal layer, at least one fiber layer, and at least one bonding layer. Each metal layer is a plate made of a metal material (e.g., aluminum, titanium, copper, iron, lead, silver, other metals, or a synthetic metal), has a thickness less than 2 mm, and is evenly formed with a plurality of mesh holes by stamping. In each metal layer, the hole diameter of each mesh hole is one to two times the thickness of the metal layer, and the spacing between each two adjacent mesh holes is one to two times the hole diameter of each mesh hole. Each fiber layer is a board composed of a fibrous material (e.g., a thin sheet of wood, wood veneer, plant fibers, chemical fibers, wool fibers, carbon fibers, or various fibrous fabrics) and has a thickness less than 2 mm. Each bonding layer is located between one metal layer and one fiber layer or, in cases where the high-pressure fire-retardant material includes a plurality of fiber layers and a plurality of bonding layers, is located either between one metal layer and one fiber layer or between two fiber layers. Each bonding layer is formed by curing an adhesive composite material, which is made of an even mixture of an adhesive and a fire-resistant material. More particularly, the adhesive is epoxy resin, polyester resin, or a like bonding material, and the fire-resistant material is silica sand, aluminum hydroxide, carbon, calcium carbonate, calcium aluminoferrite, calcium aluminosilicate, aluminum oxide, iron oxide, silicon oxide, various metal oxides and minerals, various metals and minerals, gypsum, stone powder, glass powder, or the like. The fire-resistant material is in the form of powder or particles, with a particle size small enough to pass through a #200 sieve. Moreover, the fire-resistant material makes up 45% to 65% by weight of the composite material. The composite material can be uniformly driven into the mesh holes and the pores of the at least one fiber layer. Once cured, the composite material forms the at least one bonding layer and is embedded in the mesh holes and the pores of the at least one fiber layer.

Another object of the present invention is to provide a method for making a high-pressure fire-retardant material having a metal layer, wherein the method includes the following steps. A metal plate is provided as a metal layer, and the metal layer is stamped to form a plurality of mesh holes. A board composed of a fibrous material is provided as a fiber layer. After an adhesive composite material is applied to the metal layer or the fiber layer, the metal layer and the fiber layer are attached to each other. A pressure is then applied to both sides of the attached-together metal layer and fiber layer via an upper mold and a lower mode, thereby pressing the composite material into the mesh holes of the metal layer and the pores of the fiber layer. The composite material, once cured, forms a bonding layer, and the upper mold and the lower mold can now be removed. Thus, the high-pressure fire-retardant material with the metal layer is formed. As the metal layer and the fiber layer are tightly bonded together by the bonding layer under high pressure, the high-pressure fire-retardant material not only has the resilience of the fiber layer and the toughness of the metal layer, but also shows outstanding fire retardancy, thanks to the fire-resistant material in the bonding layer that is simultaneously and uniformly driven into the mesh holes and the fiber layer. More specifically, a fire which has burned an outermost layer of the high-pressure fire-retardant material and reached the bonding layer will be stopped by the fire-resistant material in the bonding layer. Furthermore, the evenly distributed mesh holes on the metal layer make it easy to drive screws into the high-pressure fire-retardant material. The toughness of the metal layer, coupled with the resilience of the fiber layer, will cause a strong holding force acting on the screws, enabling the screws to bear greater forces than conventionally allowed, without getting loose. In addition, the high-pressure fire-retardant material can be made into different shapes by varying the shapes of the upper and lower molds used to press-form the high-pressure fire-retardant material; thus, application of the high-pressure fire-retardant material is significantly widened.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a perspective view of a preferred embodiment of the present invention;

FIG. 2 is an exploded perspective view of the preferred embodiment depicted in FIG. 1;

FIG. 3 is a sectional view of another preferred embodiment of the present invention; and

FIG. 4 is the flowchart of a manufacturing method according to the present invention.

### DETAILED DESCRIPTION OF THE INVENTION

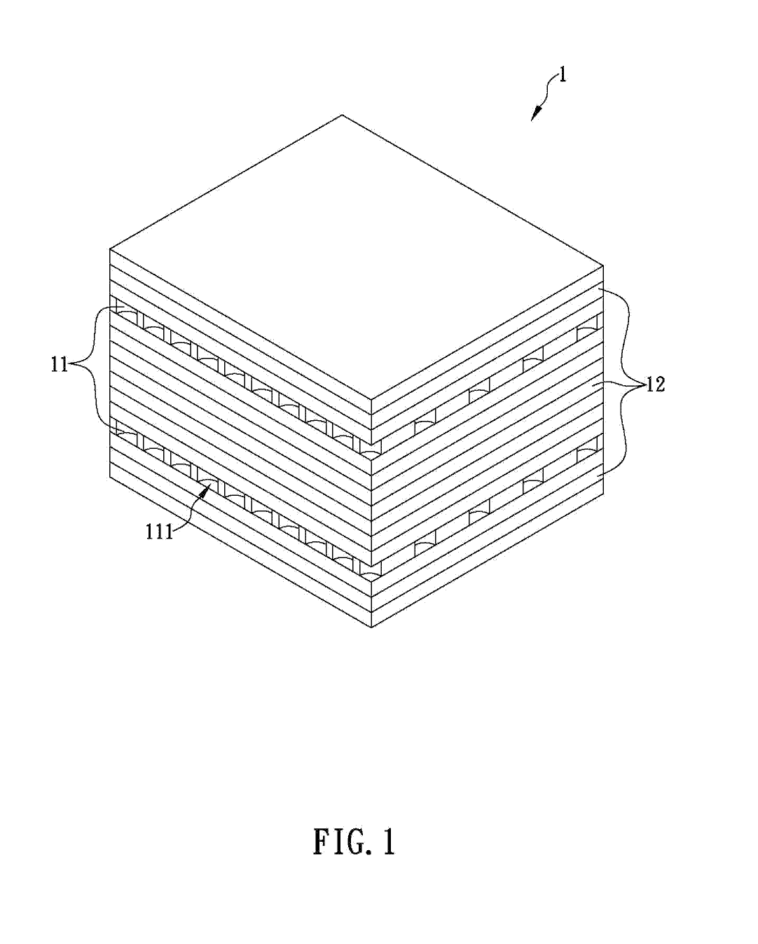

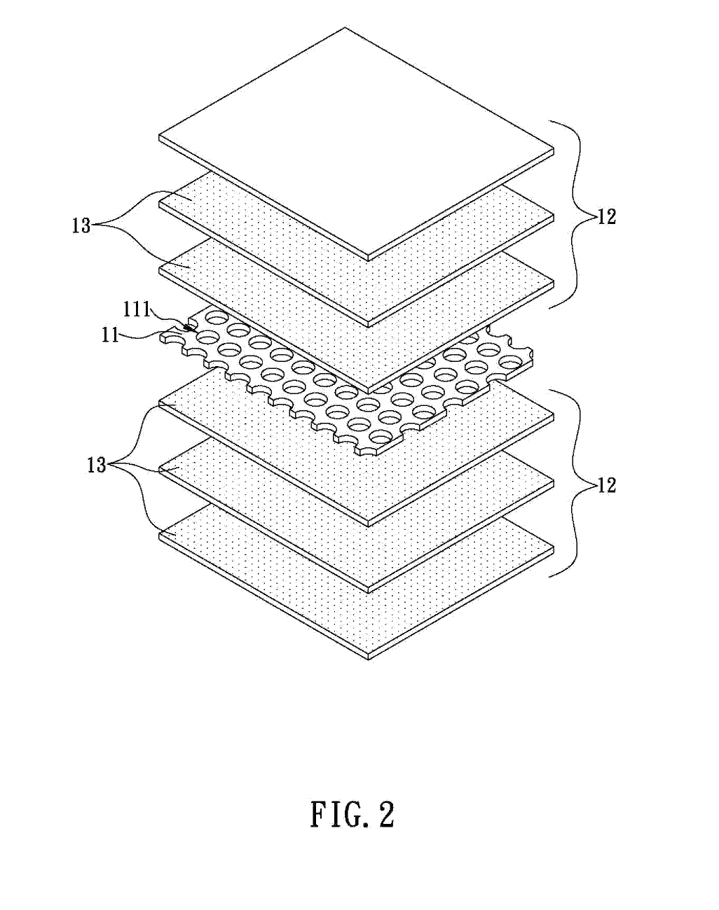

The present invention discloses a high-pressure fire-retardant material with a metal layer. In a preferred embodiment of the present invention as shown in FIGS. 1 and 2, the high-pressure fire-retardant material 1 includes at least one metal layer 11, at least one fiber layer 12, and at least one bonding layer 13. Each metal layer 11 is a plate made of a metal material (e.g., aluminum, titanium, copper, iron, lead, silver, other metals, or a synthetic metal) and is formed, by a stamping process, with a plurality of evenly distributed mesh holes 111. In this preferred embodiment, the thickness of each metal layer 11 is less than 2 mm; and in each metal layer 11, all the mesh holes 111 are circular through holes, with the hole diameter of each mesh hole 111 being one to two times the thickness of the metal layer 11, and the spacing between each two adjacent mesh holes 111 being one to two times the hole diameter of each mesh hole 111. It is understood, however, that the specifications and shapes of the present invention are by no means limited to those cited above and shown in the drawings. For example, the mesh holes 111 may be rectangular, parallelogrammic, hexagonal, or of other shapes, and the hole diameter of each mesh hole 111 and the spacing between each two adjacent mesh holes 111 may also be adjusted as appropriate. It should be pointed out that the mesh holes 111 in the drawings are shown in partial view for the sake of clarity.

Each fiber layer 12 is a board composed of a fibrous material (e.g., a thin sheet of wood, wood veneer, plant fibers, chemical fibers, wool fibers, carbon fibers, or various fibrous fabrics). In this preferred embodiment, each fiber layer 12 is less than 2 mm thick and is a pre-fabricated board bonded to one of the at least one metal layer 11, thus forming part of the high-pressure fire-retardant material 1. In practice, however, the making of the at least one fiber layer 12 is not limited to the foregoing. For instance, it is feasible to spread a fibrous material over one side of each metal layer 11 and then form the fibrous material spread on one side of each metal layer 11 into one fiber layer 12, as detailed below.

In this preferred embodiment, referring to FIG. 1 and FIG. 2, the high-pressure fire-retardant material 1 (see FIG. 1) includes two metal layers 11 and multiple fiber layers 12. Each fiber layer 12 is attached to one metal layer 11 or another fiber layer 12 to jointly form the high-pressure fire-retardant material 1. In practice, the number of the metal layers 11 or of the fiber layers 12 may be increased or decreased to adjust the overall thickness of the high-pressure fire-retardant material 1. It should be pointed out that, when multiple metal layers 11 are used to make the high-pressure fire-retardant material 1, the metal layers 11 need not be formed of the same metal. For example, one of the metal layers 11 may be made of aluminum, and another metal layer 11, of lead. Similarly, it is not necessary that the multiple fiber layers 12 are made of the same material; in other words, the material(s) of the fiber layers 12 may vary freely and be in any combination to suit practical needs. In this preferred embodiment, the high-pressure fire-retardant material 1 is made by evenly applying a layer of adhesive composite material over one or two sides of each fiber layer 12, then attaching one of the one or two sides of each fiber layer 12 that are coated with the composite material either to one side of one metal layer 11 or to one side of another fiber layer 12, and repeating the foregoing steps until all the fiber layers 12 and metal layers 11 are attached to one another. It should be pointed out that the composite material, which in the foregoing steps is applied to the fiber layers 12, may alternatively be applied to one or two sides of each metal layer 11, before one or two fiber layers 12 are attached to the one or two sides of each metal layer 11. Once the composite material is applied to one side of each metal layer 11, it is feasible to spread the fibrous material over the composite material-coated side of each metal layer 11, as stated in the previous paragraph, thereby eliminating the need to pre-fabricate the fiber layers 12 from the fibrous material. All changes or modifications readily conceivable by a person skilled in the art should fall within the scope of the present invention.

The composite material is made by mixing an adhesive and a fire-resistant material evenly, wherein the fire-resistant material makes up 45% to 65% of the composite material by weight. In this preferred embodiment, the fire-resistant material constitutes 60% by weight of the composite material. The adhesive is a bonding material such as epoxy resin or polyester resin. The fire-resistant material, on the other hand, is silica sand, aluminum hydroxide, carbon, calcium carbonate, calcium aluminoferrite, calcium aluminosilicate, aluminum oxide, iron oxide, silicon oxide, various metal oxides and minerals, various metals and minerals, gypsum, stone powder, glass powder, or the like and is in a powdery or granular form. In this preferred embodiment, the fire-resistant material has a particle size smaller than 75 μm, meaning that the particles of the fire-resistant material can pass through a sieve of #200 mesh size (the number following the sign # denoting the number of mesh openings per inch). When multiple metal layers 11 or multiple fiber layers 12 are used in making the high-pressure fire-retardant material 1, there must be one layer of composite material between each metal layer 11 and each fiber layer 12 attached thereto or between each two fiber layers 12 that are attached to each other. As stated above, the multiple layers of composite material need not be made of the same ingredients or made at the same ratio of ingredients. The composition of the fire-resistant material or of the adhesive or the ratio between the fire-resistant material and the adhesive is freely adjustable and may vary according to practical needs.

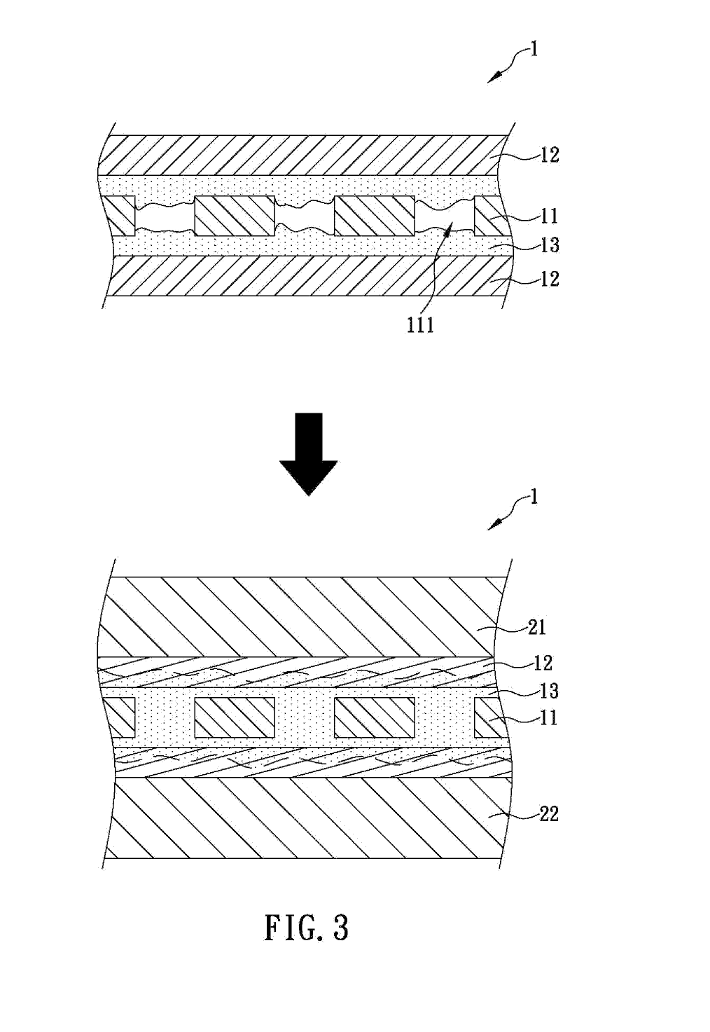

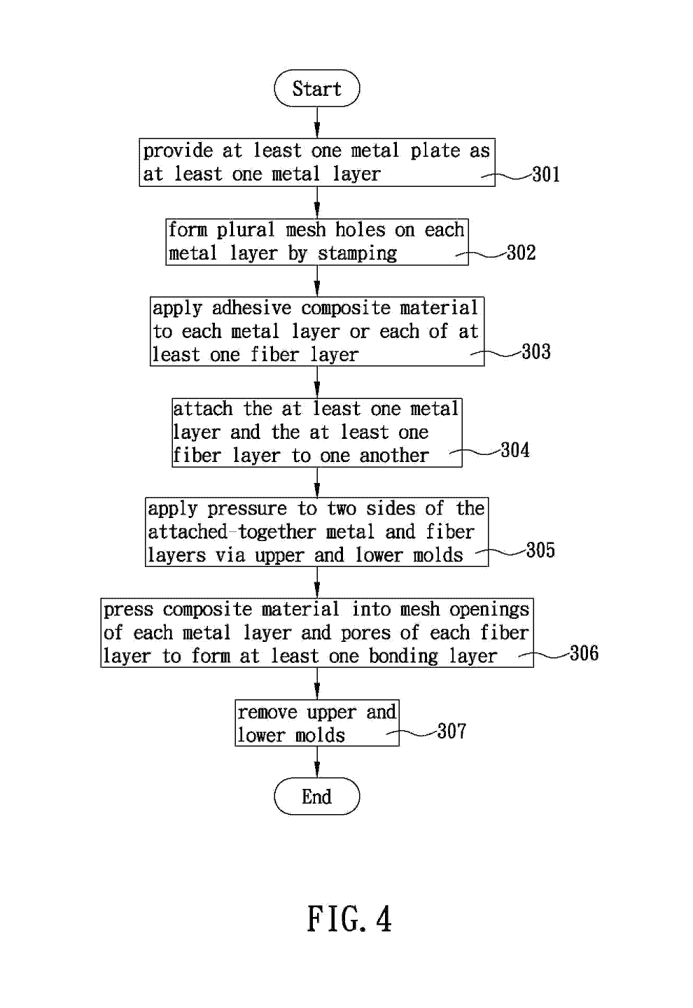

The method for making the high-pressure fire-retardant material 1 of the present invention is now detailed with reference to FIG. 3, which shows another preferred embodiment, in conjunction with the flowchart in FIG. 4. As shown in FIG. 3 and FIG. 4, the method for making the high-pressure fire-retardant material 1 includes the following steps:

(301) A plate is formed of metal and provided as the metal layer 11.

(302) The metal layer 11 is stamped to form a plurality of mesh holes 111.

(303) An adhesive composite material is applied to the metal layer 11 or each of the fiber layers 12.

(304) The metal layer 11 and the fiber layers 12 are attached to one another.

(305) A pressure is applied to two sides of the attached-together metal layer 11 and fiber layers 12 via an upper mold 21 and a lower mold 22.

(306) The composite material is pressed into the mesh holes 111 of the metal layer 11 and the pores of the fiber layers 12 to form the bonding layer 13.

(307) The upper mold 21 and the lower mold 22 are removed.

In this second preferred embodiment, the high-pressure fire-retardant material 1 includes one metal layer 11, two fiber layers 12, and one bonding layer 13 for bonding the fiber layers 12 and the metal layer 11 tightly together. As previously stated, it is feasible to make multiple plates of the same metal or different metals and use these plates as the metal layers 11 of the high-pressure fire-retardant material 1. It is also feasible to make multiple boards of different fibrous materials and use these boards as the fiber layers 12. After the side of each fiber layer 12 that is coated with the composite material (of which the fire-resistant material makes up 50% by weight in this second preferred embodiment) is attached to one of two sides of the metal layer 12 according to steps (301) to (304), a pressure not lower than 100 tons per square meter is continuously applied to the two sides of the metal layer 11 by means of the upper mold 21 and the lower mold 22 respectively. During the pressure application process, the composite material is evenly driven into not only the mesh holes 111 but also the pores of the fiber layers 12 (to the extent indicated by the dashed-lines in FIG. 3). Also, the fiber layers 12 are compacted by the pressure such that the material density of the fiber layers 12 is increased. It should be pointed out that steps (303) and (304) may be changed in a different embodiment of the present invention. For example, after the metal layer 11 is coated with the adhesive composite material, a fibrous material is spread over the composite material-coated sides of the metal layer 11. When a pressure is subsequently applied in step (305) by the upper mold 21 and the lower mold 22 to the two sides of the attached-together metal layer 11 and fiber layers 12, the fibrous material spread over the aforesaid sides of the metal layer 11 is press-formed into the fiber layers 12.

Once the composite material is cured and forms the bonding layer 13 that bonds the metal layer 11 and the fiber layers 12 closely together, the high-pressure fire-retardant material 1 of the present invention is completed. Pressure application by the upper mold 21 and the lower mold 22 can now be removed. As stated above, a manufacturer may freely increase or decrease the number of the metal layer 11 or the number of the fiber layers 12 according to practical needs, so the present invention is not limited to what is shown in the drawings. Moreover, the metal layer 11 is not necessarily contained in the high-pressure fire-retardant material 1 as an inner layer; the metal layer 11 may alternatively be attached to the high-pressure fire-retardant material 1 as an outermost layer. In steps (305) and (306), the manufacturer may, depending on production requirements, choose an upper mold 21 and a lower mold 22 that have specific configurations for press-forming the metal layer 11 and the fiber layers 12 into a specific shape during the pressure application process. These specifically configured molds also contribute to keeping the high-pressure fire-retardant material 1 in the specific shape after the composite material is cured and forms the bonding layer 13. Further, although step (307) states “the upper mold 21 and the lower mold 22 are removed”, a manufacturer may use pre-made decorative panels as the upper and lower molds 21 and 22 and, once the high-pressure fire-retardant material 1 is press-formed by the upper and lower molds 21 and 22, allow the molds to be directly and adhesively attached to the outermost layers of the high-pressure fire-retardant material 1. Hence, step (307) is not an essential step in the present invention and should not be viewed as a limitation imposed on the present invention.

Referring again to FIG. 3 and FIG. 4, as the metal layer 11 and the fiber layers 12 are tightly bonded by the bonding layer 13 under high pressure, the high-pressure fire-retardant material 1 not only possesses the resilience of the fiber layers 12 and the toughness of the metal layer 11, but also exhibits excellent fire retardancy due to the fact that the fire-resistant material in the bonding layer 13 is simultaneously and uniformly driven into the mesh holes 111 and the pores of the fiber layers 12. Therefore, should a fire burn an outermost layer of the high-pressure fire-retardant material 1 and reach the bonding layer 13, the fire-resistant material in the bonding layer 13 will stop the fire from burning. Furthermore, the mesh holes 111 evenly distributed over the metal layer 11 make it easy to fasten screws to the high-pressure fire-retardant material 1, and thanks to the toughness of the metal layer 11 and the resilience of the fiber layers 12, a strong holding force will be applied to the screws to prevent the screws from getting loose under a greater force than traditionally allowed. Besides, a manufacturer may impart different shapes to the upper and lower molds 21 and 22 used to press the high-pressure fire-retardant material 1, thereby shaping the high-pressure fire-retardant material 1 differently for a wider variety of applications. It can be known form the above that the disclosed high-pressure fire-retardant material with a metal layer advantageously features a light weight, high toughness, and good processability, in addition to its fire retarding property.

While the invention herein disclosed has been described by means of specific embodiments, numerous modifications and variations could be made thereto by those skilled in the art without departing from the scope of the invention set forth in the claims.

What is claimed is:

1. A high-pressure fire-retardant material with a metal layer, comprising:
at least a metal layer which is a plate made of a metal material and is evenly formed with a plurality of mesh holes by stamping;
at least a fiber layer which is a board composed of a fibrous material; and
at least a bonding layer which is provided between a said metal layer and a said fiber layer and is embedded in corresponding said mesh holes and pores of the fiber layer, each said bonding layer being formed by curing an adhesive composite material, wherein the adhesive composite material is made by evenly mixing an adhesive and a fire-resistant material.

2. The high-pressure fire-retardant material of claim 1, wherein each said metal layer has a thickness less than 2 mm, each said mesh hole has a hole diameter one to two times the thickness of the metal layer, and each two adjacent said mesh holes are spaced by a distance one to two times the hole diameter.

3. The high-pressure fire-retardant material of claim 2, wherein when there are a plurality of said fiber layers and a plurality of said bonding layers, each said bonding layer is provided between a said metal layer and a said fiber layer or is attached between two said fiber layers and embedded in the pores thereof.

4. The high-pressure fire-retardant material of claim 2, wherein each said fiber layer has a thickness less than 2 mm.

5. The high-pressure fire-retardant material of claim 3, wherein each said fiber layer has a thickness less than 2 mm.

6. The high-pressure fire-retardant material of claim 4, wherein the fire-resistant material is silica sand, aluminum hydroxide, carbon, calcium carbonate, calcium aluminoferrite, calcium aluminosilicate, aluminum oxide, iron oxide, silicon oxide, various metal oxides and minerals, various metals and minerals, gypsum, stone powder, or glass powder; is in form of powder or particles; has a particle size small enough to pass through a sieve with 200 mesh openings per inch; and makes up 45% to 65% by weight of the adhesive composite material.

7. The high-pressure fire-retardant material of claim 5, wherein the fire-resistant material is silica sand, aluminum hydroxide, carbon, calcium carbonate, calcium aluminoferrite, calcium aluminosilicate, aluminum oxide, iron oxide, silicon oxide, various metal oxides and minerals, various metals and minerals, gypsum, stone powder, or glass powder; is in form of powder or particles; has a particle size small enough to pass through a sieve with 200 mesh openings per inch; and makes up 45% to 65% by weight of the adhesive composite material.

8. The high-pressure fire-retardant material of claim 6, wherein the adhesive is a bonding material selected from the group consisting of epoxy resin and polyester resin.

9. The high-pressure fire-retardant material of claim 7, wherein the adhesive is a bonding material selected from the group consisting of epoxy resin and polyester resin.

10. A method for making a high-pressure fire-retardant material having a metal layer, the method comprising the steps of:
providing at least a metal layer which is a plate formed of metal;
stamping each said metal layer such that a plurality of mesh holes are formed on each said metal layer;
providing at least a fiber layer which is a board composed of a fibrous material;
applying an adhesive composite material to each said metal layer or each said fiber layer, wherein the adhesive composite material is made by evenly mixing an adhesive and a fire-resistant material;
attaching the at least a metal layer and the at least a fiber layer to one another;
applying a pressure to two sides of the attached-together at least a metal layer and at least a fiber layer via an upper mold and a lower mold such that the adhesive composite material is pressed into the mesh holes of the at least a metal layer and pores of the at least a fiber layer; and
curing the adhesive composite material to form at least a bonding layer, thereby completing the high-pressure fire-retardant material.

11. The method of claim 10, wherein the upper mold and the lower mold keep applying a pressure of at least 100 tons per square meter to the two sides of the attached-together at least a metal layer and at least a fiber layer respectively.

12. A method for making a high-pressure fire-retardant material having a metal layer, the method comprising the steps of:
providing at least a metal layer which is a plate formed of metal;
stamping each said metal layer such that a plurality of mesh holes are formed on each said metal layer;
applying an adhesive composite material to each said metal layer, wherein the adhesive composite material is made by evenly mixing an adhesive and a fire-resistant material;
spreading a fibrous material over a side or sides of each said metal layer to which the adhesive composite material has been applied;
applying a pressure to two sides of a stack of the at least a metal layer via an upper mold and a lower mold such that the fibrous material forms at least a fiber layer and the adhesive composite material is pressed into the mesh holes of the at least a metal layer and pores of the at least a fiber layer; and
curing the adhesive composite material to form at least a bonding layer, thereby completing the high-pressure fire-retardant material.

13. The method of claim 12, wherein the upper mold and the lower mold keep applying a pressure of at least 100 tons per square meter to the two sides of the stack respectively.
